(19) United States
(12) Patent Application Publication
(10) Pub. No.: US 2006/0257019 A1
(43) Pub. Date: Nov. 16, 2006

(54) Phased projector illumination method

(76) Inventors: Ian McDowall, Woodside, CA (US); Mark Bolas, Mountain View, CT (US)

Correspondence Address: IAN McDOWALL;FAKESPACE LABS, 241 POLARIS AVE, MOUNTAIN VIEW, CA, 94043, US

(21) Appl. No.: 11/088,121

(22) Filed: Mar. 22, 2005

Related U.S. Application Data
(60) Provisional application No. 60/554,868, filed on Mar. 22, 2004.

(51) Int. Cl. G06K 9/00

(52) U.S. Cl. 382/162

(57) ABSTRACT

A method for increasing the signal to noise ratio in systems which employ 3 dimensional patterns projected from a projector and imaged by an electronic image sensor is conveyed.

This application claims priority to U.S. Provisional Application 60/554,868, filed Mar. 22, 2004.

### BACKGROUND

Digital projection has typically been used for projecting images for people to view. There is a developing need for coupling projected images with cameras and other sensors for computer applications. Machine vision sometimes benefits from projecting a pattern on the surfaces being seen by a camera. Other uses for projected illumination may also be enabled with this technology. This structured illumination can be created in wavelengths not visible to people so as not to interfere with other viewing by people or by cameras collecting images for human consumption. Creation of the structured illumination can take many forms. In some cases, time varying patterns are desirable. In many cases, the levels of illumination required for cameras to acquire a good low noise image or quality sensor data may be inconveniently bright. Especially in mobile applications for example where power and weight requirements want to be minimized, simply making the projector brighter and using a lower F number lens may be undesirable.

### DESCRIPTION OF FIGURES

FIGS. 1a through 1d are color perspective images from an image modulation device according to the present disclosure.

FIG. 2 is a color perspective image illustrating the pattern from an image modulation device according to the present disclosure.

FIGS. 3a through 3c are side views of alternative configurations for phased projector illumination methods as disclosed.

FIGS. 4a through 4c illustrate steps of a phased projector illumination method as disclosed.

### SPECIFICATION

We create a projector in the normal way with a light source, light modulating device (for example an LCOS panel, or a DMD chip, or a DLP system), and projection optics. In addition we add to this system of components the ability to flicker the light source. This may be accomplished by several means, including using a modulated LED light source, using an electro optical shutter, using a second light modulating device, using a light source which inherently oscillates, or using a mechanical chopper. The light source is modulated in such a way as to facilitate the detection of the light by a sensor which may be a camera. The images acquired by the camera or other sensor can be processed in such a way as to greatly increase the signal to noise ratio of the projected pattern relative to the background.

The modulation of the light source can be simply periodic or can have the qualities of a spread spectrum signal so as to permit multiple projector/camera units to work together in the same volume of space with minimal interference between the units. Note that a single projector might be used with one or more cameras and that there is really no limit as to the ratio of cameras to projectors or vice versa. More projectors might be used where a camera has a lot of processing power and is expensive to replicate; the additional projectors would minimize shadowing. Multiple cameras and multiple projectors could be used in applications where a number of sensors are used to map a complicated surface geometry for example.

The phased illumination algorithm can be implemented in several ways. The first method is as follows:

With pattern loaded on the image modulation device. Clear frame storage buffer.
Loop for some N camera frames
   Turn on illumination
   Capture a frame on the camera
   Add frame into storage buffer
   Turn off illumination
   Capture a frame on the camera
   Subtract frame from storage buffer

Note that the accumulation of frames in the storage buffer will be such that illuminated pixels in the image will get progressively brighter. Non illuminated pixels should trend to zero over a number of frames. Naturally, this works for a single photo detector such as a photodiode also. A photo detector has the advantage of being very fast and can keep up with a modulated LED light source or laser source with ease.

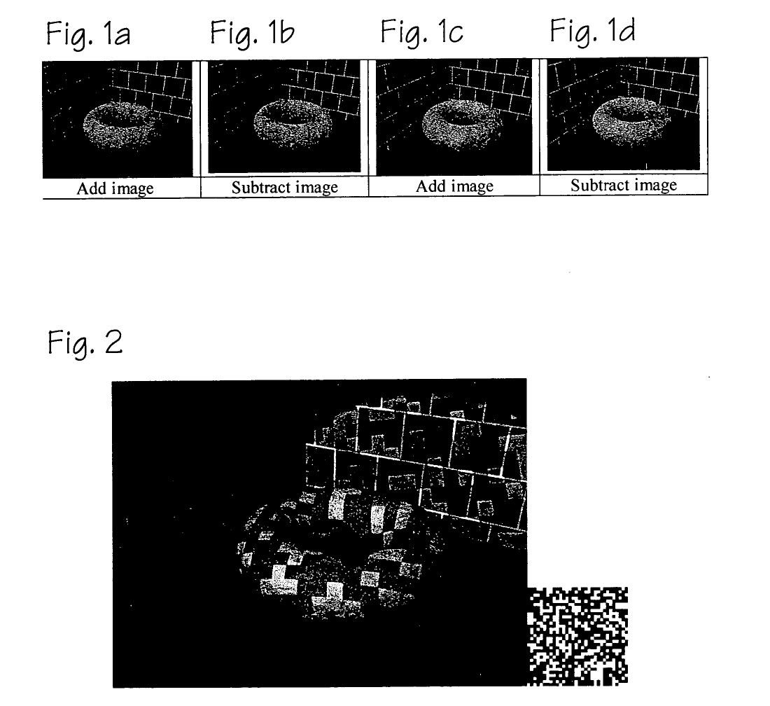

In FIGS. 1a through 1d, the random squares pattern is hardly discernable in the scene. Using the phased illumination and the addition and subtraction of subsequent frames, the pattern becomes immediately evident and much easier for a machine to process, as shown in FIG. 2. Note that in the above case, the illumination is simply flashed synchronously with the acquisition of the frames and is added or subtracted depending on the state of the illumination.

Clearly, in addition to simply a + − + − + − + − pattern, there are other patterns which are more desirable in other situations. First, multiple sensors working in the same environment will interfere if all the sensors are doing the + − + − sequence. As the timing of the various sensors go in and out of phase so they will interfere more or less but in general, there will be interference. Other sequences such as Gold codes, or linear feedback shift registers can be used so as to provide multiple sensors in the environment with data where each of several sources are creating patterns with overlapping coverage as would be desired in a spatial tracking scenario. Along the lines of telecom type codes, error correction capability such as viterbi coding or reed Solomon error correction codes could be used (viterbi codes use a probability function for the data which could be attractive). It would also be possible to simply run each source at a n integer multiple of some base frequency ie 10, 20, 40 etc. Note also that standard telecom and networking clock recovery schemes can be used at the sensor to establish the correct clocking sequence. Also note that the data from the sensor could go to N different clock recovery modules in the case where the sensor is picking up data from N sources simultaneously. The synchronous clock between the source and the receiver could also come from an out of band type communication—an rf signal for example.

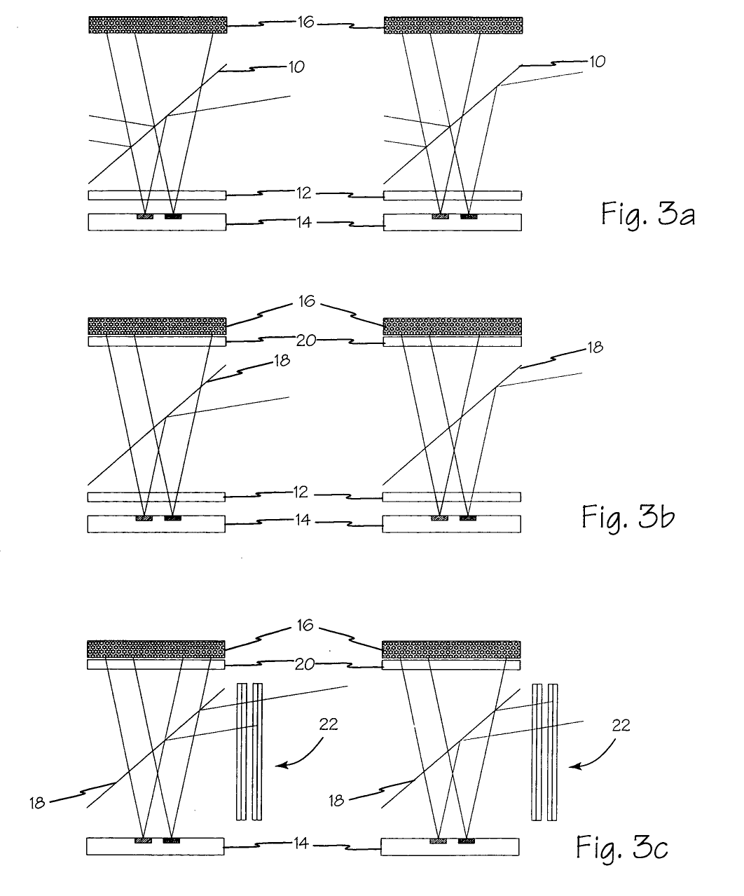

Additionally, the electro-optic and micro-machined imaging devices used may enable the designer to project a pattern and its inverse without having to reload the pattern into the device. Methods to accomplish this for a typical micro mirror device and for a typical LCOS device are shown schematically in FIGS. 3a through 3c.

In FIG. 3a, backlight 16 is shaded at top, diagonal element 10 is a polarizing beam splitter. The following colored beams represent:
Cyan=unpolarized
Green=Linear S
Red=Linear P
Blue=circular left
Purple=circular right

Rectangle 12 is a switchable ¼ wave plate, and element 14 is the LCOS display.

In FIG. 3b, backlight 16 is shaded at top, with linear polarizer 20 on backlight. Diagonal element 18 is a 50/50 beam splitter. The following colored beams represent:
Cyan=unpolarized
Green=Linear S
Red=Linear P
Blue=circular left
Purple=circular right

Rectangle 12 is a switchable ¼ wave plate, and element 14 is the LCOS display.

In FIG. 3c, backlight 16 is shaded at top, with linear polarizer 20 on backlight. Diagonal element 18 is a 50/50 beam splitter. The following colored beams represent:
Cyan=unpolarized
Green=Linear S
Red=Linear P
Blue=circular left
Purple=circular right

Vertical Rectangles form a ½ wave switch rotater & polarizer 22, and element 14 is the LCOS display.

The reason these configurations are advantageous is that now, the phased illumination can be improved further through actively illuminating the other pixels to make the differences even larger to improve the signal to noise ratio. This improvement is not required to make the basic approach function but does enhance the signal to noise ratio. To be clear—when we are projecting the pattern, we do so and then the next time slice when we would normally be off, instead we project the inverse pattern. The sensor behaves as before and is adding when we project the desired pattern and subtracting the rest of the time. In this case, the subtraction is going to subtract a larger value (because of the inverse illumination) and the contrast ratio will have been improved.

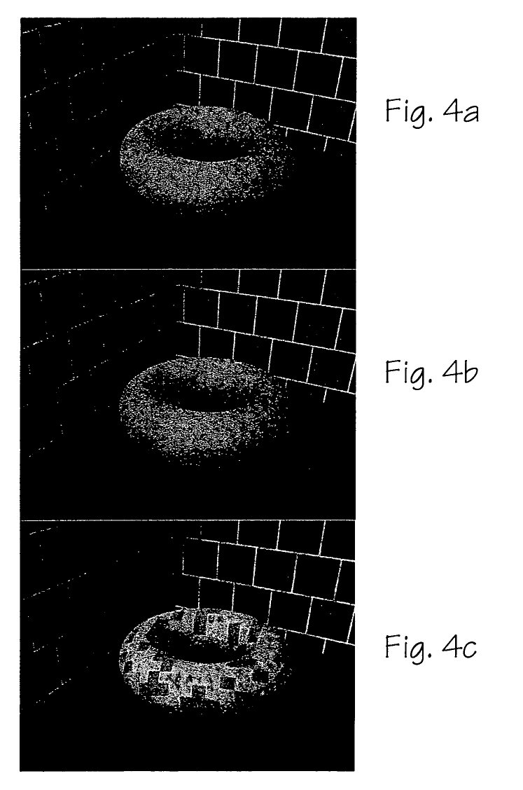

As shown in FIG. 4a, the image is “captured” with a random dot pattern projected into the simulated scene. In this “captured” image as shown in FIG. 4b, the dot pattern has been inverted relative to image of FIG. 4a. As shown in FIG. 4c, the difference of the images shown in FIGS. 4a and 4b (brightness brought up) showing the contrast ratio of the pattern given the light and “inverse light” case. This type of illumination is enabled through the use of the LCOS displays with switchable ½ or ½ wave plates as described. It is also possible to do this with a DLP where the light source is perpendicular to the DLP chip and the +12 degree image and the −12 degree image can be selectively imaged out into the scene.

### APPLICATIONS

Scanning

Extracting projected patterns from a scene is a major issue in shape scanning. Algorithms such as the stripe boundary code algorithm at Stanford and others require extracting the stripes from the image. Using the phased projected illumination, we could pull out the stripes more easily.

Tracking

The phased projector lets a photo detector (or an array) determine its position in the projected image. A simple way to achieve this is to encode each pixel with a unique value and to then simply read out the current value. If multiple pixels are seen by the sensor, the codes and algorithm can be constructed to accommodate this. With multiple projected sources, one can determine the sensor's location is 3 dimensional space—ie the intersection of the detected rays from the image sources. Using a small triangle of sensors, the 6 DOF orientation and position can be determined. An interesting aspect of these patterns is that they might have an absolute and a relative component. By knowing the spacing of the detectors, there must be a way to get small relative motions.

Control

The data passed need not be static—it cold be control information from the light source to N receivers, all getting the data they need and nothing else. This line of sight communication is happening simultaneously for all the N receivers. There could be a million of them. It's a million way parallel bus. One can control a large number of small robotic devices for example—a swarm where each automaton can be tagged based on it's spatial relationship to sources, and can be given control information over the same communications link.

Smart Surfaces

The data can be embedded into existing projectors. Thus, these spatial patterns can appear on a surface being used for projection. This enables a small device looking at some part of the screen to know where in the image it is looking. This would facilitate tracking inside a Cave environment for example. It also enables smart rear projected white boards and design review stations as described by Alias' Bill Buxton for example.

Robotics

In robotics and mechanical design, a significant amount of effort is exerted in getting data back as to the position and orientation of joints in a mechanical linkage. These measurements are generally accomplished by measuring the device causing the joint to move—an encoder on a motor for an example. By using the phased projector and a positional reader, one can envisage a robotic system which uses (or is augmented with) the actual position and orientation of segments or end effectors, instead of the indirect measure from the encoders. In precise robotics, measuring the end effector's actual position could assist the control loop in adaptively refining the final position of the end effectors. There is another class of device this may enable—flexible robotics in which the linkage is allowed to be compliant instead of stiff and the measured position of elements is used in the overall control loop rather than the feedback from individual sensors on the joints.

We claim:

1. an imaging system in which an image is projected, imaged, subsequently the inverse image is projected and imaged and the two images are differenced more than once
